(19) United States
(12) Patent Application Publication
(10) Pub. No.: US 2024/0335799 A1
(43) Pub. Date: Oct. 10, 2024

(54) Mixing Device for Providing a Foamed or Foamable Plastic

(71) Applicant: Henkel AG & Co. KGaA, Duesseldorf (DE)

(72) Inventors: Mario Metzler, Goetzis (AT); Guenter Baldauf, Hohenweiler (AT); Daniela Stancheva-Schwind, Frastanz (AT)

(21) Appl. No.: 18/746,651

(22) Filed: Jun. 18, 2024

Related U.S. Application Data
(63) Continuation of application No. PCT/EP2022/085927, filed on Dec. 14, 2022.

(30) Foreign Application Priority Data
Dec. 20, 2021 (EP) 21215935.4

(51) Int. Cl. B01F 23/20; B01F 23/235; B01F 27/09; B01F 27/272; B01F 35/00; B01F 101/00

(52) U.S. Cl. CPC B01F 23/291; B01F 23/2351; B01F 27/09; B01F 27/2722; B01F 35/55; B01F 2101/2805

(57) ABSTRACT

Disclosed is a mixing device (1) for mixing a first component (2) with a second component (3) for providing a foamed or foamable plastic (5), comprising a mixing chamber (11), a stirrer (30) that is arranged in the mixing chamber (11) and can be rotated about an axis of rotation (31), a first inlet opening (13) for the supply of the first component (2) into the mixing chamber (11), a second inlet opening (14) for the supply of the second component (3) into the mixing chamber (11), wherein the first inlet opening (13) has an axial spacing from the second inlet opening (14), and an outlet opening (16) for the exit of the plastic (5) from the mixing chamber (11).

The invention relates to a mixing device for mixing a first component with a second component to provide a foamed or foamable plastic.

WO 2017/004637 A1 discloses a mixing device with a mixing chamber and a stirrer, rotatably arranged therein about an axis of rotation, wherein a first inlet opening is provided for supplying a first liquid component into the mixing chamber, and a second inlet opening for supplying a second liquid component into the mixing chamber. The first inlet opening and the second inlet opening are located at different axial heights in the mixing chamber and have a corresponding axial spacing. Viewed in the axial direction, the second inlet opening is located between the first inlet opening and an outlet opening through which the mixture of the first and second components can exit the mixing chamber. According to WO 2017/004637 A1, the mixing of the first component and the second component only takes place at the axial height of the second inlet opening so that there should be no or only minimal contaminations at the axial height of the first inlet opening.

Furthermore, WO 2017/004637 A1 discloses using polyol as the first component and isocyanate with water as the second component to produce a polyurethane foam. The polyol is charged with air before entering the mixing chamber. This air conditioning (introduction, dissolving, homogenization) takes place in pressure tanks, for which a time expenditure of several hours to a few days is usually needed. The air in the polyol promotes the desired foam structure of the polyurethane. However, the quality of the foam structure depends on many parameters such as the pressure and temperature in the mixing chamber. If the outlet opening of the mixing chamber is used as a nozzle for metering-out polyurethane foam, wherein the outlet opening is opened at the beginning of a metering process and closed again at the end of the metering process, undesirable pressure fluctuations can occur in the mixing chamber, which makes it difficult to provide a uniform foam structure.

The invention is therefore based on the object of providing a mixing device with which a consistently good foam quality of the foamed or foamable plastic can be achieved even under changing conditions.

The object of the invention is solved by the combination of features according to claim 1. Exemplary embodiments of the invention can be found in the claims which are dependent on claim 1.

According to the invention, a flow brake is provided between the first and second inlet openings, viewed in the axial direction, by means of which the mixing chamber is divided into a first mixing chamber and into a second mixing chamber and which serves to prevent a flow of the second component into the first mixing chamber. The stirrer has, in a first axial section that is located in the first mixing chamber, first means for providing a premix of gas and the first component. In a second axial section, which lies in the second mixing chamber, the stirrer has second means for mixing the premix, which passes through the flow brake into the second mixing chamber, with the second component.

A gas inlet opening can be provided in axial proximity to the first inlet opening for the first component, through which at least a portion of the gas can be introduced directly into the first mixing chamber. The provision of the premix of the gas and the first component can involve breaking the gas down into small microbubbles. Preferably, these microbubbles are evenly distributed in the first component so that a homogeneous premix consisting of the first component and the distributed small microbubbles arises.

In principle, it is conceivable that the first component is charged with air before entering the mixing chamber. But even in this case, the first means of the stirrer serve to convert into the premix the first component with the gas contained therein, for example in dissolved form. The gas present in dissolved form can fall below its saturation pressure when entering the mixing chamber, which causes gas bubbles to bubble out. These gas bubbles are then broken down into small microbubbles by the first means. However, it is preferred that a larger portion of the gas is injected directly into the mixing chamber through said gas inlet opening. This directly injected portion of the gas can be greater than 80%. Preferably, the directly injected portion is 100%, if an air portion in the first component is disregarded that has naturally or unintendedly entered the first component due to manufacturing processes. The invention therefore makes it possible to dispense with the otherwise usual upstream gas- or air-conditioning of the first component.

For example, the first component can be a mixture of polyol and water, and the second component can be isocyanate. When polyol, water and isocyanate are mixed, polyurethane is formed with gaseous CO₂ being released, which foams the polyurethane and creates polyurethane foam. The small microbubbles serve as nuclei for the formation of foam cells. In addition to the amount of added water, the density and foam structure of the polyurethane foam can be influenced by specifically influencing the quality of the premix consisting of polyol and the microbubbles contained therein.

A gas valve unit can be provided upstream of the gas inlet opening, by means of which the amount of supplied gas can be precisely adjusted. Preferably, the gas valve unit comprises a mass flow controller and a pressure control valve, wherein an outlet of the mass flow controller is connected to an inlet of the pressure control valve. An outlet of the pressure control valve is connected to the gas inlet opening in the mixing chamber. By means of the pressure control valve, a constant pressure can be set at which the gas (preferably air) is injected into the mixing chamber. This allows the injection pressure to be kept constant even when there is varying pressure in the mixing chamber, which simplifies the provision of an exact amount of gas by the gas valve unit.

The flow brake can be designed variously, provided it is suitable for dividing the mixing chamber into a first mixing chamber and a second mixing chamber and is also suitable for preventing a flow of the second component into the first mixing chamber. The flow brake can comprise a restrictor, whereby, albeit to only slight extent, a higher pressure prevails in the first mixing chamber than in the second mixing chamber. This prevents the second component, such as isocyanate, from entering the first mixing chamber and causing undesirable chemical reactions or contamination there. The premix (of the first component and gas) then passes through the restrictor into the second mixing chamber to be mixed with the second component. The mixture of premix and second component then leaves the mixing chamber through the outlet opening. The flow brake can also be provided by a suitable design of the mixing chamber itself in that, for example, the wall of the mixing chamber is designed at least sectionally, and in particular adapted to the components to be mixed, in such a way that the technical effect of the flow brake described above is achieved.

The flow brake should also fulfill its inventive task even if it cannot be completely excluded that a very small part of the second component enters the first mixing chamber.

The restrictor can be formed by a radial gap between a mixing chamber wall and the stirrer. Preferably, the stirrer is constructed to be substantially rotationally symmetrical. It can have a shaft collar, wherein the radial gap can extend between the shaft collar and the mixing chamber wall. In the case of a rotationally symmetrical stirrer, the shaft collar can have a circular cross-section with an outer diameter. The mixing chamber can be substantially cylindrical and have a cylindrical lateral surface with a circular cross-section. The inner diameter of the cylindrical lateral surface is slightly larger than the outer diameter of the shaft collar. In the axial direction, the shaft collar can extend a few millimeters, for example 5 to 15 mm. Preferably, the stirrer and the cylindrical mixing chamber are aligned coaxially to each other so that, when there is a smooth shaft collar, a radial gap arises which is consistently large in the circumferential direction. The radial gap can be smaller than 0.5 mm and even smaller than 0.1 mm.

The dimensions of the mixing chamber and the stirrer depend on the required output (weight/unit of time) of the plastic to be provided. Typical values for the output range from 0.05 g/s to 120 g/s. For example, the mixing chamber can have an axial length of 12 mm to 25 cm. The values of the inner diameter of a cylindrical mixing chamber can be from 6 mm to 30 mm.

In one exemplary embodiment, the stirrer can be moved in the axial direction within the mixing chamber. It can preferably assume an axial closed position by means of which the outlet opening of the mixing chamber is closed. If the stirrer is displaced from this closed position, the outlet opening opens so that the plastic can be metered out of the mixing chamber. In an alternative embodiment, it is conceivable that the mixing chamber is displaced in the axial direction with respect to the stirrer in order to thereby preferably assume an axial closed position by means of which the outlet opening of the mixing chamber is closed. If the mixing chamber is moved from this closed position, the outlet opening opens so that the plastic can be metered out of the mixing chamber.

The outlet opening can be arranged substantially coaxially to the axis of rotation of the stirrer, wherein the axial closed position can represent an axial end position of the stirrer. The mixing chamber can accordingly have a conically tapering end region with an outlet opening arranged centrally thereto. In its closed position, the stirrer can rest on this end region and thereby close the outlet opening. When the stirrer is then moved slightly from this closed position, an outlet gap opens between the stirrer and the conically tapering end region. The plastic then reaches the outlet opening through this outlet gap.

In one exemplary embodiment, the axial position of the stirrer is used to adjust the flow cross-section of an arbitrarily shaped outlet gap upstream of the outlet opening between the axially displaceable stirrer and the mixing chamber in order to thereby influence or regulate the pressure in the mixing chamber. This exemplary embodiment could therefore also be designed without a conically tapering end region. Furthermore, it is not mandatory that the closed position be an axial end position.

The first section of the stirrer and the second axial section of the stirrer are preferably connected to each other in a rotationally fixed manner. This results in a stirrer with a comparatively simple structure, which is preferably constructed in one piece or is composed of only two or three parts firmly connected to one another. The axial sections of the stirrer therefore rotate at the same rotational speed in the mixing chamber.

In one exemplary embodiment, the first means of the first axial section of the stirrer differ from the second means of the second portion of the stirrer. This takes into account the fact that the requirements and objectives in the first mixing chamber differ from those in the second mixing chamber. While in the first mixing chamber the gas should be finely dispersed, beaten or finely distributed in the first component, in the second mixing chamber, the first component (with the gas contained therein) and the second component should be mixed together. However, it is also conceivable that the first means of the first axial section of the stirrer correspond to the second means of the second section of the stirrer.

The first means of the first axial section of the stirrer and/or the further means of the second section of the stirrer can have a plurality of rows of projections or radial teeth extending in the radial direction, wherein the rows can extend substantially in the axial direction. In one exemplary embodiment, the rows run straight and parallel to the axis of rotation of the stirrer. However, the rows can also be inclined at an angle of inclination to the axis of rotation so that an axial flow is promoted when the stirrer rotates. The angle of inclination in the first axial section can be different from the angle of inclination of the second axial section. For example, it is conceivable that, in the first axial section, the angle of inclination is 0°, while in the second axial section, the angle of inclination is different from 0° (for example 5 to 15°) in order to prevent, in addition to the flow brake, the second component from overflowing into the first axial region.

A radial projection/tooth of one row can be offset in the axial direction from a radial projection of an adjacent row. Better mixing and better dispersal of the gas can thereby be achieved.

If rows of radial projections are provided in both the first axial section and in the second axial section of the stirrer, the radial projections of the second section can be spaced further apart than the radial projections of the first section. The radial projections of the second axial section can also be larger than the radial projections of the first axial section. This measure enables a finer mixing or dispersal in the first mixing chamber to be achieved.

Generally speaking, the first means of the first axial section have a higher pitch number than the second means of the second axial section. A higher pitch number means that more projections or teeth are provided per unit area.

The radial projections can each have a cross-sectional area that changes in the radial direction. Viewed in the radial direction, the projections can taper towards the outside or also widen.

The first means of the first axial section of the stirrer and/or the second means of the second section of the stirrer can each have a plurality of blades by which material which is pushed outwards by the centrifugal force is guided radially inwards. This promotes good and homogeneous mixing or dispersal of the gas.

To achieve further mixing effects, the blades can have small openings. When the stirrer rotates, part of the material caught by a blade is therefore pressed through the small openings.

The invention is explained in more detail with reference to the exemplary embodiments shown in the drawings. In the figures:

### BRIEF DESCRIPTION OF THE DRAWINGS

FIG. 1 shows a mixing device according to the invention;

FIG. 2 shows a stirrer of the mixing device of FIG. 1;

FIG. 3 shows another stirrer; and

FIG. 4 shows three variants of a first axial section of the stirrer.

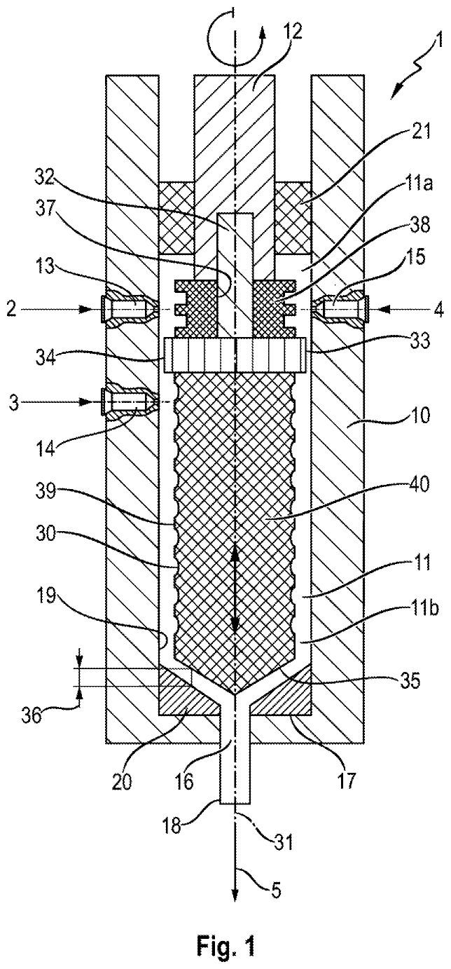

FIG. 1 shows a mixing device according to the invention, which is denoted in its entirety by 1. The mixing device 1 has a housing 10 which bounds a mixing chamber 11. A stirrer 30 which is rotatably mounted about an axis of rotation 31 is arranged in the mixing chamber 11. The stirrer 30 is substantially rotationally symmetrical to the axis of rotation 31. The stirrer 30 is driven by a drive shaft 12, which is only partially shown. For connection to the drive shaft 12, the stirrer 30 has a pin-shaped shaft connection 32. Preferably, the connection between the drive shaft 12 and the shaft connection 32 is a force-fitting connection.

Three inlet openings are provided in the housing 10: firstly, there is a first inlet opening 13 through which a first component can be supplied to the mixing chamber 11. A second inlet opening 14 is provided at an axial distance from the first inlet opening 13. The axial distance between the first inlet opening and the second inlet opening 14 can be a few millimeters, for example 3 to 20 mm.

At the same axial height as the first inlet opening 13, a gas inlet opening 15 is provided in the housing 10, through which a gas 4 can be injected into the mixing chamber 11. The gas 4 is preferably air (the gas can also be nitrogen or CO₂).

The mixing chamber 10 can be used to produce a foamed or foamable plastic. For example, polyurethane foam can be produced by means of the mixing chamber 10. For this purpose, a liquid mixture of polyol and water as the first component 2 is introduced into the mixing chamber 11 through the first inlet opening 13. Isocyanate, which reacts with the polyol to form polyurethane, is selected as the second component 3. The polyurethane foam exits the mixing chamber 11 through an outlet opening 16, which is arranged coaxially to the axis of rotation 31 and is located at an axial end 17 of the mixing chamber 11. The outlet opening 16 is formed by a nozzle 18. An inner diameter of the nozzle 18 can be, for example, 1 to 8 mm or 2 to 5 mm. A length of the nozzle 18 can be 2 to 50 mm or 30 mm. The flow of the produced plastic or the foamed or foamable polyurethane foam is denoted by 5 in FIG. 1. The produced plastic exits the mixing chamber 11 in an axial direction.

The stirrer 30 has a cylindrical shaft collar 33, the outer diameter of which is slightly smaller than an inner diameter of the cylindrical mixing chamber 11. Accordingly, a small radial gap 34 is formed between the shaft collar 33 and a mixing chamber wall 19. The radial gap 34 can be regarded as part of a restrictor or flow brake through which the mixing chamber 11 is divided into a first mixing chamber 11a and a second mixing chamber 11b.

The stirrer 30 can be moved in the axial direction (in the direction of the axis of rotation 31). FIG. 1 shows the stirrer 30 in an axial position in which an outlet gap 36 exists between a conical stirrer tip 35 of the stirrer 30 and a funnel-shaped insert 20 which is arranged at the axial end 17 of the mixing chamber 11. It is therefore possible for the plastic that has been produced in the mixing chamber 11 to exit from the mixing device 1 through the nozzle 18. In a closed position, the conical stirrer tip 35 rests on the insert 20, thereby closing the outlet gap 36. In the closed position of the stirrer 30, the outlet opening 16 is therefore closed. The axial extension of the gap between the stirrer tip 35 and the insert 20 can assume values between 0 mm (closed position) and 2.5 mm. The axial position of the stirrer 30 or the axial extent of the outlet gap 36 can be used to set a specific pressure in the mixing chamber 11. Means for precisely adjusting the axial position of the stirrer 30 are not shown in FIG. 1.

The axial stroke (difference between the closed position and an upper end position) is dimensioned such that the shaft collar 33 or the flow brake is always located between the first inlet opening 13 and the second inlet opening 14 when viewed in the axial direction. The first inlet opening 13 and the gas inlet opening, which is offset by 180° here in this exemplary embodiment, thus always open into the first mixing chamber 11a of the mixing chamber 11. The second inlet opening 14, however, always opens into the second mixing chamber 11b, regardless of the axial position of the stirrer 30.

A gas valve unit, which is not shown in FIG. 1, can be connected to the gas inlet opening 4. The gas valve unit serves to inject a precise gas flow into the mixing chamber 11. It has been found that during the production of the plastic, the amount of gas injected into the mixing chamber has a major influence on the foam structure of the plastic.

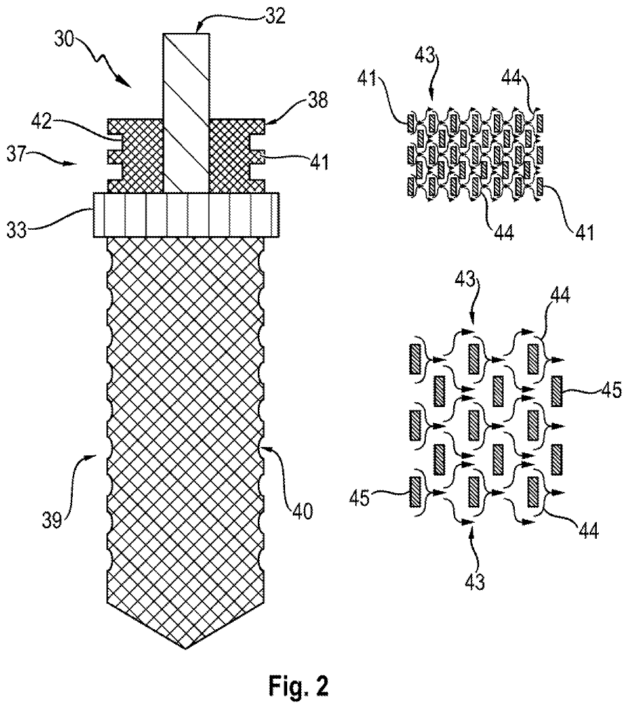

For dispersing the gas 4 and/or for mixing it with the first component 2, the stirrer 30 has first means 38 on a first axial section 37, which are described in more detail below with reference to FIGS. 2 to 4. The first axial section 37 of the stirrer 30 is located in the first mixing chamber 11a of the mixing chamber 11. The first mixing chamber 11a is bounded by the shaft collar 33 and a seal 21 which is inserted between the drive shaft 12 and the mixing chamber wall. In a second axial section 39 which extends from the shaft collar 33 to the stirrer tip 35, second means 40 are provided for mixing with the second component 3 a premix, comprising the first component 2 and the gas 4. The second axial section 39 is located in the second mixing chamber 11b of the mixing chamber 11.

Before the exemplary embodiments shown in FIGS. 2 to 4 for the first means 38 and second means 40 are discussed in more detail, the operation of the mixing chamber 1 will be briefly described based on the metering of the polyurethane or the polyurethane foam 5: polyol with water as the first component 2 is fed through the first inlet opening 13 to the first mixing chamber 11a. At the same time, air is injected through the gas inlet opening 15 into the first mixing chamber 11a. By rotating the stirrer 30 and therefore also by rotating the first means 38, the injected gas 4 is dispersed in the first component 2. This creates small microbubbles of gas, which are finely distributed in the first component 2. The rotational speed of the stirrer can be 1000 to 6000 rpm or 1500 to 4000 rpm.

Due to the given pressure in the first mixing chamber 11a, the premix from the first mixing chamber 11a passes through the radial gap 34 into the second mixing chamber 11b. There, the premix (polyol, water, microbubbles) is mixed with isocyanate (second component 3) by the second means 40. During the reaction of polyol, water and isocyanate, CO₂ is produced in addition to polyurethane. The microbubbles act as nuclei for the formation of CO₂ bubbles, which form foam cells in the polyurethane. The polyurethane can be metered out of the mixing chamber 11 through the outlet opening 16. Due to the restrictive effect of the flow brake or the radial gap 34, a (small) pressure gradient results between the first mixing chamber 11a and the second mixing chamber 11b. The pressure gradient ensures that there is practically no flow from the second mixing chamber 11b into the first mixing chamber 11a.

This prevents isocyanate or a mixture of isocyanate, polyol and water from entering the first mixing chamber 11a and causing undesirable contamination there.

When a metering process is to be terminated, the stirrer 30 is moved from the position shown in FIG. 1 to the closed position in order to close the outlet opening 16. In so doing, the drive shaft 12 is braked so that the stirrer 30 no longer rotates within the mixing chamber 11. Axially lowering the stirrer tip 35 until it rests on the insert 20 and running out the stirrer 30 can be coordinated in such a way that the stirrer tip 35 cleans and clears the insert 20 by means of a residual rotation. At the same time, the gas valve unit (not shown) is closed to prevent polyol from entering the valve unit or too much gas from accumulating in the first mixing chamber 11a. Due to the closed valve unit and the closed outlet opening 16, the mixing chamber is sealed off from the environment after the metering process has ended. At the beginning of another metering process, the two components 2, 3 and the gas 4 are again fed into the mixing chamber with the once again rotating and axially displaced stirrer 30.

FIG. 2 shows the stirrer 30 of FIG. 1 in isolation. In addition, FIG. 2 shows two flattened views, each of a part of the circumference of the stirrer 30. Components or features in FIGS. 2 to 4 that are similar or identical to components and features in FIG. 1 are provided with the same reference signs.

The first means 38 for distributing the gas and generating the microbubbles comprise projections or teeth 41 which can have a rectangular cross-section. The projections 41 extend outward in a radial direction starting from a cylindrical core 42. The projections 41 with the rectangular cross-sections, wherein a longer edge of the rectangular cross-section extends in the axial direction and therefore transversely to the circumferential direction, are arranged in rows which extend in the axial direction. The course of an axial row is highlighted in the partial section of the flattened view of the circumference in FIG. 2 by the arrows 43. It can also be seen that the projections 41 of adjacent rows are arranged axially offset. When the stirrer 30 rotates and the projections 41 are therefore moved through the first component, this leads to an evasive or displacement movement of the first component with the gas contained therein. The evasive or displacement movement is schematically represented by the arrows 44.

Similar to the first means 38, the second means 40 have projections or teeth 45 which are rectangular in cross-section and are arranged in axial rows (see arrows 43). Here, too, an axial offset of projections 45 of adjacent rows 43 is provided. From FIG. 2, it is clear that the pitch (number of projections per unit area on the circumference of the stirrer 30) in the first axial section 37 is larger than the pitch in the second axial section 39. The pitch in the first axial section 37 relative to the pitch in the second axial section can—regardless of the particular arrangement and design of the projections 41,45 of FIG. 2—lie within a range between 2 and 5. The larger pitch leads to a particularly fine and good dispersal of the gas in the first mixing chamber. Accordingly, the evasive and displacement movement 44 of the material in the first mixing chamber 11a is sharper-edged and more delicate.

A further difference between the projections 41 in the first axial section 37 and the projections 45 of the second axial section 39 is the radial height of the individual projections. A greater height (greater extension in the radial direction) of the projections 41 promotes fine and intensive mixing/dispersal in comparison to the rather flat projections 45.

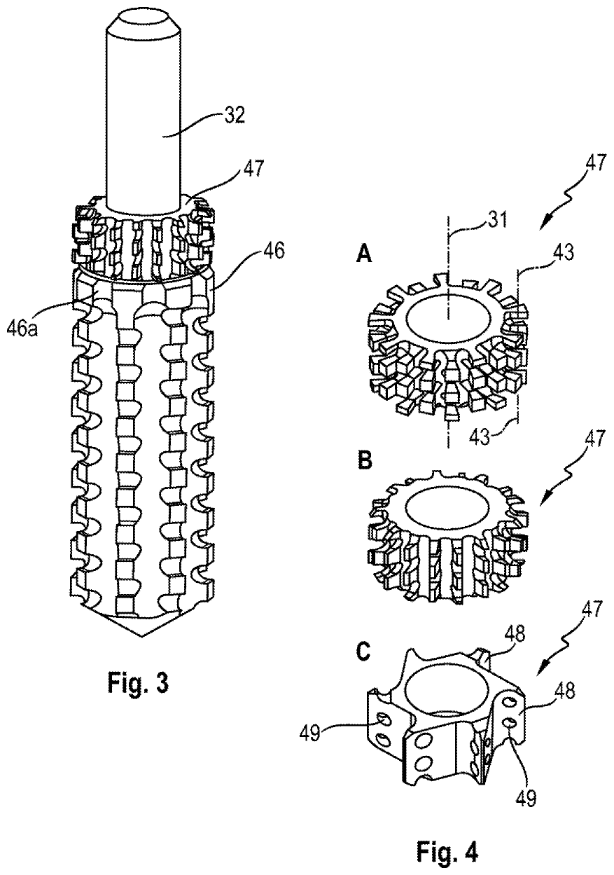

FIG. 3 shows another exemplary embodiment of the stirrer 30. In contrast to the shaft collar 33 of FIGS. 1 and 2 which has a smooth cylindrical lateral surface, a shaft collar 46 is provided here which is interrupted by axial grooves 46a. The regions of the shaft collar 46 between two adjacent grooves 46a can also be referred to as projections 46b, wherein these are wider in the circumferential direction than the projections 41 of the first axial section 37 and the projections 45 of the second axial section 39 and, in interaction with the adjacent mixing chamber wall 19 (see FIG. 1), also represent a flow brake, which prevents the second component from entering the first mixing chamber 11a. The preventive effect of the interrupted shaft collar 46 is less than that of the shaft collar 33 of the exemplary embodiment of FIGS. 1 and 2. However, this also reduces the pressure gradient between the first mixing chamber 11a and the second mixing chamber 11b.

Preferably, the first means 38 of the stirrer 30 from FIG. 2 is designed as a separate ring element that can be pushed onto the pin-shaped shaft connection 32. This simplifies the manufacture of the stirrer 30.

FIG. 3 also shows that the projections 41 of the first axial section can be formed by a separate ring element 47 which can be pushed onto the pin-shaped shaft connection 32. This simplifies the production of the stirrer 30.

FIG. 4 shows different variants for the ring element 47. FIG. 4B shows the variant as used in FIG. 3. The projections 41 taper radially outwards so that the end face of the projections, which is directly opposite the mixing chamber wall 19, is relatively small. As a result, the first component 2 and the gas 4, which are each supplied radially inwards, can be supplied comparatively easily when the stirrer 30 is rotating. The time intervals during which the end faces are directly opposite the respective inlet openings 13, 15 during the rotation of the stirrer 30 are very short.

In contrast thereto, in the variant of FIG. 4A, the projections 41 increase in their cross-section, which leads to relatively large frontal or peripheral areas per projection 41. During the rotation of the stirrer 30, the time durations during which the end faces of the projections 41 are directly opposite the inlet openings are correspondingly larger. This tends to make it more difficult to introduce the first component 2 and the gas 4. However, the projections 41 thereby have an undercut in the radial direction, which causes the material to be mixed to be pressed inwards during the rotation of the stirrer. This allows a reduction of negative effects on good mixing that can occur due to centrifugal forces that act on the material to be mixed.

In the variants of FIGS. 4A and 4B, the rows 43 of the projections 41 run parallel to the axis of rotation 31. However, they could also run at an angle so that the material located in the first mixing chamber 11a is pressed in the direction of the seal 21 (see FIG. 1, i.e. away from the shaft collar 33). This leads to a stronger mixing/dispersal in the first mixing chamber 11a.

FIG. 4C shows a variant of the ring element 47 in which several blades 48 are arranged on the circumference. The blades 48 press the material in the first mixing chamber 11a towards the interior of the mixing chamber and counteract a centrifugal force. For better mixing/dispersal, the blades have small openings 49. A portion of the material captured by a blade is pressed through these openings 49, which promotes good mixing/dispersal. The axial height of the openings is offset from the axial height of openings of a neighboring blade. This makes it possible to avoid possible dead spaces within the first mixing chamber 11a in which material can settle that is not optimally mixed.

### LIST OF REFERENCE SIGNS

1 Mixing chamber
2 First component
3 Second component
4 Gas
5 Plastic (polyurethane foam)
10 Housing
11 Mixing chamber (11a first mixing chamber; 11b second mixing chamber)
12 Drive shaft
13 First inlet opening
14 Second inlet opening
15 Gas inlet opening
16 Outlet opening
17 Axial end
18 Nozzle
19 Mixing chamber wall
20 Insert
21 Seal
30 Stirrer
31 Axis of rotation
32 Pin-shaped shaft connection
33 Shaft collar
34 Radial gap
35 Stirrer tip
36 Outlet gap
37 First axial section
38 First means
39 Second axial section
40 Second means
41 Projection/teeth
42 Core
43 Row
44 Evasive and displacement movement
45 Projection/teeth
46 Shaft collar (46a groove; 46b projection)
47 Ring element
48 Blade
49 Opening

1. A mixing device (1) for mixing a first component (2) with a second component (3) to provide a foamed or foamable plastic (5), comprising:
a mixing chamber (11),
a stirrer (30) that is arranged in the mixing chamber (11) and can rotate about an axis of rotation (31),
a first inlet opening (13) for the supply of the first component (2) into the mixing chamber (11),
a second inlet opening (14) for the supply of the second component (3) into the mixing chamber (11), wherein the first inlet opening (13) is axially spaced from the second inlet opening (14),
an outlet opening (16) for the plastic (5) to exit from the mixing chamber (11),
wherein, viewed in the axial direction, a flow brake is provided between the first inlet opening (13) and the second inlet opening (14), by means of which the mixing chamber (11) is divided into a first mixing chamber (11a) and a second mixing chamber (11b) and which serves to prevent a flow of the second component (3) into the first mixing chamber (11a), wherein the stirrer (30) has first means (38) in a first axial section (37) that lies in the first mixing chamber (11a) for providing a premix of a gas and the first component (2), and has second means (40) in a second axial section (39) that lies in the second mixing chamber (11b) for mixing the second component (3) with the premix, which passes through the flow brake into the second mixing chamber (11b).

2. The mixing device (1) according to claim 1, wherein a gas inlet opening (15) is provided in axial proximity to the first inlet opening (13) through which at least a portion of the gas (4) can be introduced directly into the first mixing chamber (11a).

3. The mixing device (1) according to claim 2, wherein a gas valve unit for regulating the amount of supplied gas is provided upstream of the gas inlet opening (15).

4. The mixing device (1) according to claim 1, wherein the flow brake comprises a restrictor.

5. The mixing device (1) according to claim 4 wherein the restrictor is formed by a radial gap (34) between a mixing chamber wall (19) and the stirrer (30).

6. The mixing device (1) according to claim 5, wherein the stirrer (30) is constructed substantially rotationally symmetrically and has a shaft collar (33), wherein a radial gap (34) extends between the shaft collar (33) and the mixing chamber wall (19).

7. The mixing device (1) according to claim 1, wherein the stirrer (30) is displaceable in the axial direction and closes the outlet opening (16) of the mixing chamber (11) in an axial closed position.

8. The mixing device (1) according to claim 7, wherein the outlet opening (16) is arranged substantially coaxially to the axis of rotation (31) of the stirrer (30), wherein the axial closed position represents an axial end position of the stirrer (30).

9. The mixing device (1) according to claim 1, wherein the first axial section (37) of the stirrer (30) and a second axial section (39) of the stirrer (30) are connected to one another in a rotationally fixed manner.

10. The mixing device (1) according to claim 1, wherein the first means (38) of the first axial section (37) of the stirrer (30) differs from the second means (40) of the second section (39) of the stirrer (30).

11. The mixing device (1) according to claim 1, wherein the first means (38) of the first axial section (37) of the stirrer (30) and/or the second means (40) of the second section (39) of the stirrer (30) have a plurality of radial projections (41, 45) which are arranged in rows (43) that extend substantially in the axial direction.

12. The mixing device (1) according to claim 11, wherein a radial projection (41,45) of a row (43) is offset in the axial direction from a radial projection (41,45) of an adjacent row.

13. The mixing device (1) according to claim 11, wherein, when rows (43) with radial projections (41,45) are provided both in the first axial section (37) and in the second axial section (39) of the stirrer (30), the radial projections (41) of the second section (37) are spaced further apart from one another than the radial projections (45) of the first section (39).

14. The mixing device (1) according to claim 11, wherein the radial projections (41, 45) each have a cross-sectional area which changes in the radial direction.

15. The mixing device (1) according to claim 1, wherein the first means (38) of the first axial section (37) of the stirrer (30) and/or the second means (40) of the second section (39) of the stirrer (30) each have a plurality of blades (48) by means of which material which is pressed outwards by centrifugal force is guided radially inwards.
